(19) United States
(12) Patent Application Publication
(10) Pub. No.: US 2008/0253008 A1
(43) Pub. Date: Oct. 16, 2008

(54) Foldable Exterior Rearview Mirror For Motor Vehicle

(76) Inventor: Milo Tseng, Yongkang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/733,323

(22) Filed: Apr. 10, 2007

(51) Int. Cl. G02B 7/182

(52) U.S. Cl. 359/876; 359/872

(57) ABSTRACT

A foldable exterior rearview mirror includes a housing, a bracket fixed to a side of a motor vehicle, and a connecting arm mounted in the housing and including a sleeve portion suitable for receiving an electric adjusting device or manual adjusting device. The manual adjusting device includes a pivot shaft and a support frame. The pivot axle includes an axle and a base fixed to a lower end of the axle. The base is mounted to the bracket. The support frame includes a cylindrical portion and a coupling portion extending outward from a periphery of the cylindrical portion. The cylindrical portion and the coupling portion of the support frame are removable engaged in the sleeve portion of the connecting arm. A user may select the manual adjusting device or the electric adjusting device to be mounted in the sleeve portion of the connecting arm.

### BACKGROUND OF THE INVENTION

The present invention relates to a foldable exterior rearview mirror for a motor vehicle. More particularly, the present invention relates to a manual foldable exterior rearview mirror that can be easily converted into or from an electric foldable exterior rearview mirror.

Exterior rearview mirrors are useful for motor vehicles during passing and turning. The exterior rearview mirrors protruding from the vehicle sides can be designed to be foldable to avoid damage during parking. FIGS. 1 and 2 illustrate a conventional electric foldable exterior rearview mirror 1 including a housing 11, a connecting arm 12 mounted in the housing 11, a mirror frame 14 mounted in the housing 11, a bracket 15, and electric adjusting device 16, and a mirror 13 mounted to the mirror frame 14. The connecting arm 12 includes a mirror frame mounting portion 121 to which the mirror frame 14 is mounted. A sleeve portion 122 extends from a side of the mirror frame mounting portion 121. The bracket 15 includes a vertical portion 151 attached to a side of a motor vehicle and a horizontal portion 152. The electric adjusting device 16 includes a coupling seat 161, a pivot shaft 162 extending through the coupling seat 161, and a support frame 163 rotatable mounted around the pivot shaft 162. The support frame 162 has an outline allowing it to be fittingly received in the sleeve portion 122 of the connecting arm 12. The coupling seat 161 is mounted to the horizontal portion 152 of the bracket 15. Thus, the housing 11 is supported by the bracket 15. The support frame 163 includes a cylindrical section 164 for receiving a speed reducer (not shown) and a motor receiving section 165 for receiving a motor (not shown). The motor receiving section 165 is generally covered by a cover 166. When the motor turns, the support frame 163 rotates about the pivot shaft 162 to turn the housing 11 relative to the bracket 15 between an unfolded position and a folded position.

A typical manual foldable exterior rearview mirror includes a housing, a connecting arm mounted in the housing, a bracket fixed to a side of a motor vehicle, and an adjusting device mounted between the bracket and the connecting arm. The housing can be manually turned between an unfolded position and a folded position. The main differences between a manual foldable exterior rearview mirror and an electric foldable exterior rearview mirror are the adjusting device and the connecting arm. Specifically, the adjusting device of an electric foldable exterior rearview mirror requires a motor and a speed reducer such that the structure and the outline of the adjusting device of the electric foldable exterior rearview mirror are significantly different from those of a manual foldable exterior rearview mirror and, thus, can not allow simple replacement therebetween. In a case that a user wishes to convert the foldable exterior rearview mirror from one type into the other, the procedure is inconvenient, time-consuming, and costly, for both the adjusting device and the connecting arm must be replaced. The manufacturers must produce various types of adjusting devices and connecting arms for both the electric foldable exterior rearview mirrors and manual foldable exterior rearview mirrors, which also increases the costs.

There is a need in a manual foldable exterior rearview mirror that can be easily converted into or from an electric foldable exterior rearview mirror.

### BRIEF SUMMARY OF THE INVENTION

The present invention solves this need and other problems in the field of exterior rearview mirrors of motor vehicles by providing, in a preferred form, a housing, a bracket adapted to be fixed to a side of a motor vehicle, and a connecting arm mounted in the housing and including a sleeve portion suitable for receiving a manual adjusting device or an electric adjusting device. A mirror is adapted to be mounted to the connecting arm. The manual adjusting device includes a pivot shaft and a support frame. The pivot axle includes an axle and a base fixed to a lower end of the axle. The base is mounted to the bracket. The support frame includes a cylindrical portion and a coupling portion extending outward from a periphery of the cylindrical portion. The cylindrical portion and the coupling portion of the support frame are removably engaged in the sleeve portion of the connecting arm. The cylindrical portion of the support frame is rotatably mounted around the axle and includes an annular compartment in a bottom face thereof. The base of the pivot shaft is rotatably received in the annular compartment of the cylindrical portion of the support frame. A user may select the manual adjusting device or the electric adjusting device to be mounted in the sleeve portion of the connecting arm. This allows the user to easily and rapidly convert a manual foldable exterior rearview mirror into or from an electric exterior rearview mirror without the need of replacing the connecting arm.

In the most preferred form, the base includes a top face having a plurality of annularly spaced first positioning holes and a plurality of annularly spaced second positioning holes. An end wall defining the annular compartment of the support frame includes a plurality of positioning grooves. A positioning mechanism is provided for positioning the support frame relative to the pivot shaft and includes a plurality of balls; a spring mounted around an upper portion of the axle that extends beyond the cylindrical portion of the support frame; and a positioning ring mounted on top of the axle. The spring is attached between the positioning ring and a top face of the cylindrical portion of the support frame to bias the cylindrical portion of the support frame toward the base. Each ball has an upper portion received in one of the positioning grooves of the support frame and a lower portion selectively received in one of the first positioning holes or one of the second positioning holes. The sleeve portion of the connecting arm includes an annular section and a frame section. The annular section includes a cylindrical hole for receiving the cylindrical portion of the support frame. The frame section includes a coupling hole for receiving the coupling portion of the support frame. The frame section of the sleeve portion of the connecting arm includes two engaging grooves respectively in two opposite lateral walls thereof. The coupling portion of the support frame includes two projections respectively on two opposite walls thereof and slidably received in the engaging grooves of the frame section of the sleeve portion of the connecting arm. Screws are extended through holes in the frame section of the sleeve portion of the connecting arm and holes in the coupling portion of the support frame for securely fixing the coupling portion of the support frame in the frame section of the sleeve portion of the connecting arm.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows an exploded perspective view of a conventional electric foldable exterior rearview mirror for a motor vehicle.

FIG. 2 is a perspective view, partly cutaway, of the conventional electric foldable exterior rearview mirror of FIG. 1.

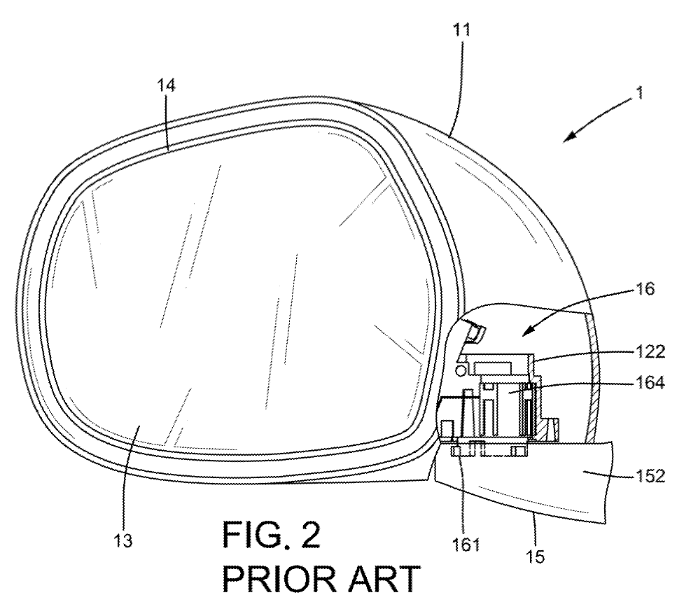

FIG. 3 is an exploded perspective view of a manual foldable exterior rearview mirror for a motor vehicle according to the preferred teachings of the present invention.

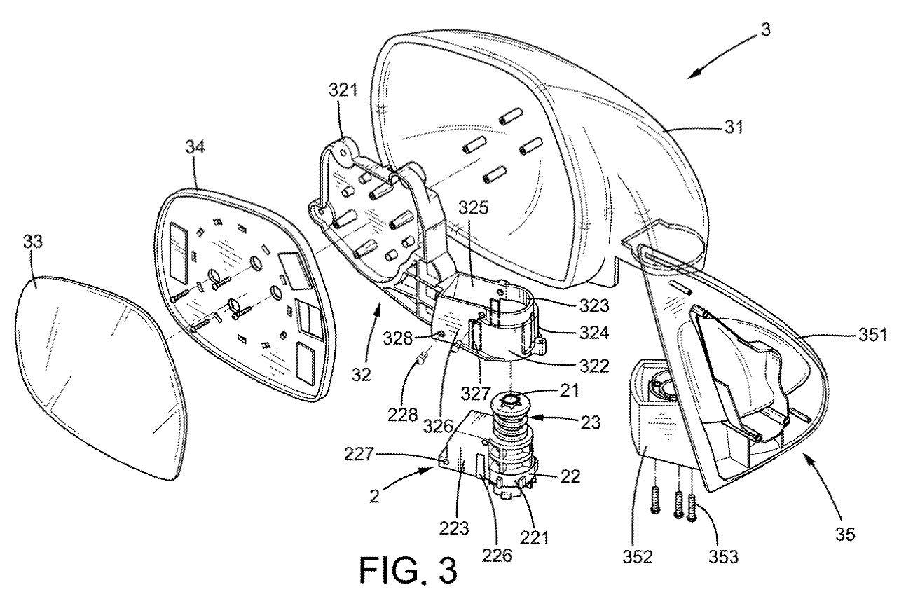

FIG. 4 is an exploded perspective view of an adjusting device of the manual foldable exterior rearview mirror of FIG. 3.

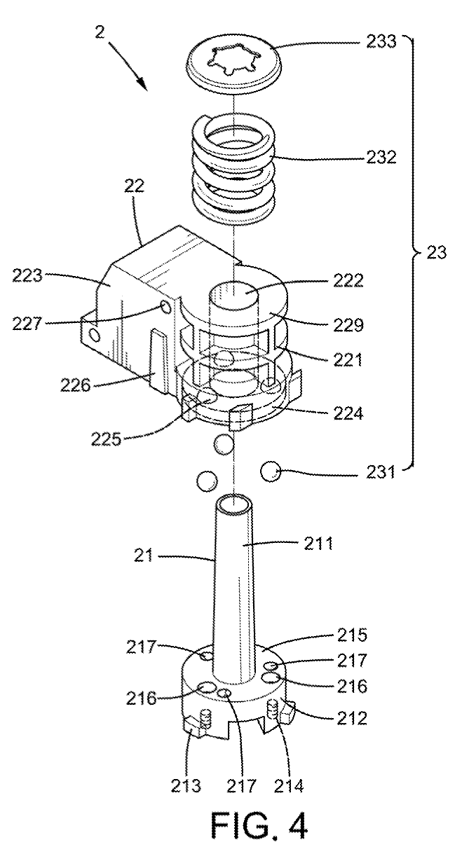

FIG. 5 is a partly-cutaway perspective view illustrating a portion of the manual foldable exterior rearview mirror of FIG. 3.

FIG. 6 is a partly-sectioned side view of a connection arm and the adjusting device of the manual foldable exterior rearview mirror of FIG. 3.

FIG. 7 is a view similar to FIG. 5, showing the exterior rearview mirror in an unfolded state.

FIG. 8 is a view similar to FIG. 7, showing the exterior rearview mirror in a folded state.

All figures are drawn for ear of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “lower”, “upper”, “end”, “portion”, “section”, “vertical”, “lateral”, “annular”, “depth,” and similar terms are used herein, it should be understood that these terms have reference only to the structure shown in the drawing as it would appear to a person viewing the drawings and are utilized only to facilitate describing the invention.

### DETAILED DESCRIPTION OF THE INVENTION

A manual foldable rearview mirror for a motor vehicle according to the preferred teachings of the present invention is shown in the drawings and generally designated 3. The manual foldable rearview 3 includes a housing 31, a connecting arm 32 mounted in the housing 31, a mirror frame 34 to which a mirror 33 is mounted, a bracket 35, and a manually operable adjusting device 2. The connecting arm 32 includes a mirror frame mounting portion 321 to which the mirror frame 34 is mounted. A sleeve portion 322 extends from a side of the mirror frame mounting portion 321. The sleeve portion 322 includes an annular section 324 defining a cylindrical hole 323 and a frame section 326 defining a coupling hole 325 that is in communication with the cylindrical hole 323. In the most preferred from shown, the frame section 326 includes two engaging grooves 327 respectively in two opposite lateral walls thereof and extending vertically.

According to the preferred form, the bracket 35 includes a vertical portion 351 attached to a side of a motor vehicle and a horizontal portion 352. The adjusting device 2 includes a pivot shaft 21, a support frame 22 rotatably mounted around the pivot shaft 21, and a positioning mechanism 23 for positioning the support frame 22 on the pivot shaft 21. The pivot shaft 21 includes an axle 211 and a base 212 fixed to a lower end of the axle 211. The base 212 is in the form of a disc including a plurality of protrusions 213 on an outer periphery thereof for coupling with the horizontal portion 352 of the bracket 35, with screws 353 extending through the vertical portion 352 of the bracket 35 into screw holes 214 in a bottom side of base 212. The base 212 further includes an annular top face 215 surrounding the axle 211 and having two sets of positioning holes 216 and 217. In the preferred form shown, a set of three annularly spaced deeper positioning holes 216 and a set of three annularly spaced shallower positioning holes 217 are defined in the top face 215 of the base 212. The support frame 22 includes a cylindrical portion 221 and a coupling portion 223 extending from a periphery of the cylindrical portion 221. The cylindrical portion 221 includes a cylindrical hole 222 for rotatably receiving the axle 211. The cylindrical portion 221 further includes an annular compartment 224 in a bottom face thereof for rotatably receiving an upper end of the base 212 of the pivot shaft 21. The annular compartment 224 includes a set of positioning grooves 225 in an end wall thereof. In the preferred form shown, the end wall of the annular compartment 224 includes three annularly spaced positioning grooves 225 in selective alignment with the sets of deeper positioning holes 216 of the set of shallower positioning holes 217. The cylindrical portion 221 of the support frame 22 has an outline allowing it to be fittingly received in the cylindrical hole 323 of the sleeve portion 322 of the connecting arm 32. The coupling portion 223 of the support frame 22 has an outline allowing to be fittingly received in the coupling hole 325 of the annular section 324 of the sleeve portion 322 of the connection arm 32. In the most preferred form shown, the coupling portion 223 of the support frame 22 includes two vertically extending projections 226 respectively on two opposite walls thereof and slidably received in the engaging grooves 327 of the frame section 326 of the sleeve portion 322. Thus, the support frame 22 can be mounted in the sleeve portion 322 of the connection arm 32, with screws 228 extending through holes 328 in the frame section 326 of the connection arm 32 into holes 227 in the coupling portion 223 of the support frame 22.

The positioning mechanism 23 includes a set of ball 231, a spring 232, and a positioning ring 233. In the preferred form shown, three steel balls 231 are utilized and each have an upper portion received in one of the positioning grooves 225 of the support frame 22 and a lower portion received in one of the deeper or shallower positioning holes 216 or 217, thereby positioning the support frame 22 and the pivot shaft 21. The spring 232 is mounted around an upper portion of the axle 211 that extends beyond the cylindrical portion 221 of the support frame 22. The spring 232 includes a lower end pressing against the top face 229 of the cylindrical portion 221. The positioning ring 233 is fixed on top of the axle 211 and presses against the upper end of the spring 232. Thus, the cylindrical portion 221 of the support frame 22 is biased the spring 232 toward the base 212.

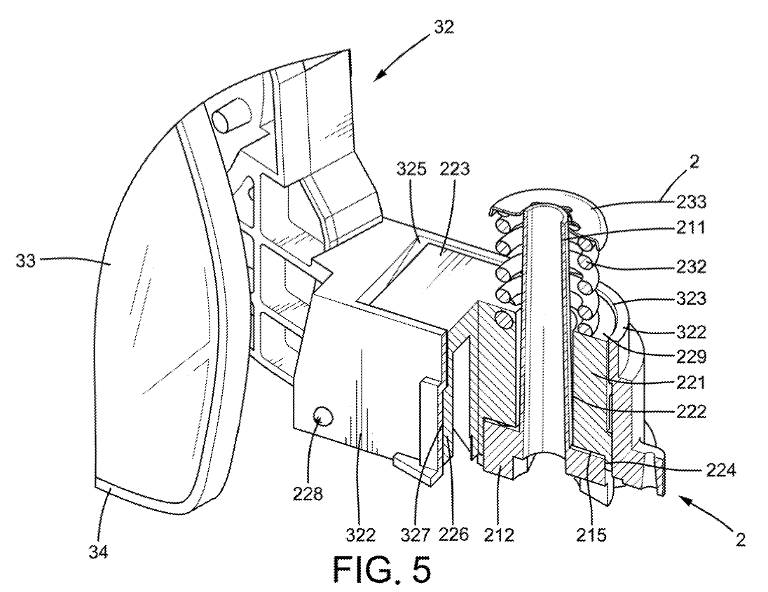

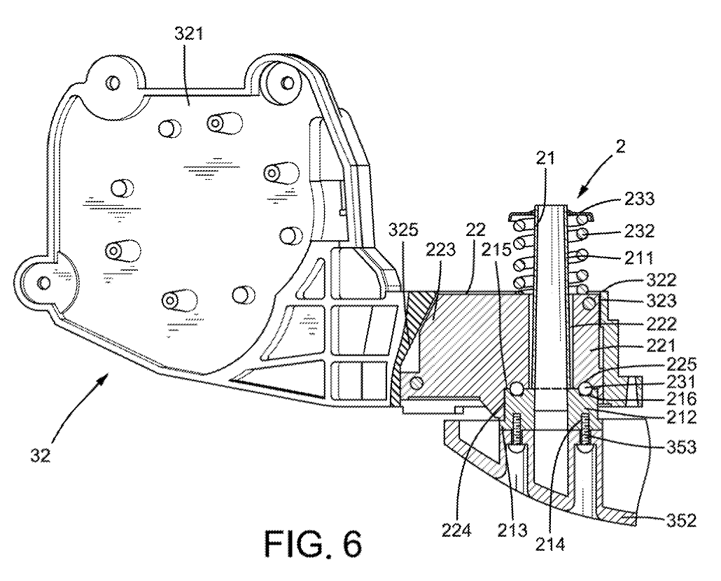

With reference to FIGS. 5 and 6, after assembly of the adjusting device 2, the cylindrical portion 221 of the support frame 22 is mounted around the axle 211 of the pivot shaft 21, with the bottom face of the cylindrical portion 221 in contact with the top face 215 of the base 212. Namely, the top end of the base 212 is fittingly received in the annular compartment 224 of the cylindrical portion 221 and positioned by the positioning mechanism 23. Nevertheless, if a rotational force is imparted to the support frame 22 and sufficiently large to urge the balls 231 to overcome the spring 232 and, hence, disengage from the positioning grooves 216 or 217, the support frame 22 is capable of pivoting about a pivot axis of the pivot shaft 21.

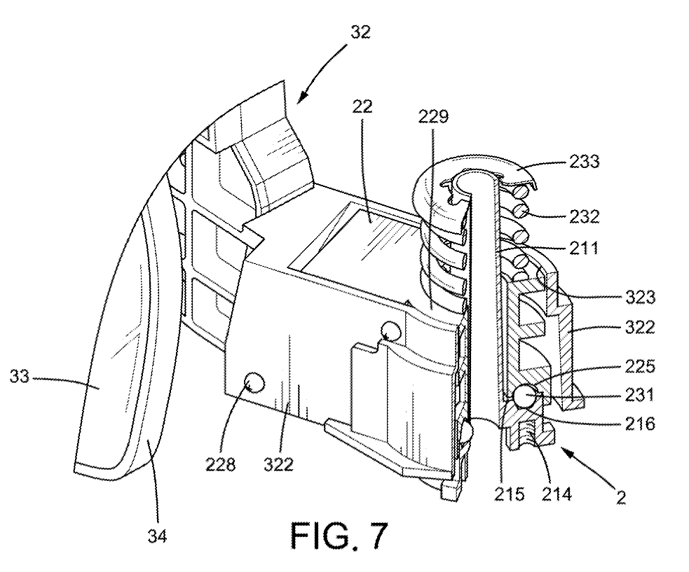

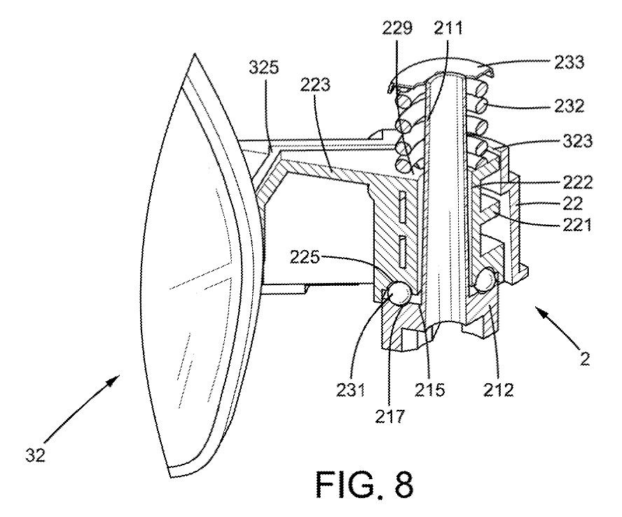

With reference to FIG. 7, the exterior rearview mirror 2 is an unfolded state when the lower portions of the balls 231 are engages in the deeper positioning holes 216 in the top face 215 of the base 212. With reference to FIG. 8, the exterior rearview mirror 3 is in a folded state when the lower portions of the balls 231 are engages in the shallower positioning holes 217 in the top face 215 of the base 212. Specifically, when a user is intended to move the exterior rearview mirror 2 from the unfolded state to the folded state, the user applies a rotational force to turn the support frame 22 and to move the balls 231 from the deeper positioning holes 216 into the shallower positioning holes 217. Operation of moving the exterior rearview mirror 3 from the folded state to the unfolded state can achieved by pivoting the support frame 22 in a reverse direction in which the balls 231 are moved from the shallower positioning holes 231 into the deeper positioning holes 216. It can be appreciated that the number and depths of the positioning holes 216 and 217 can be modified without adversely affecting operation of the adjusting device 2.

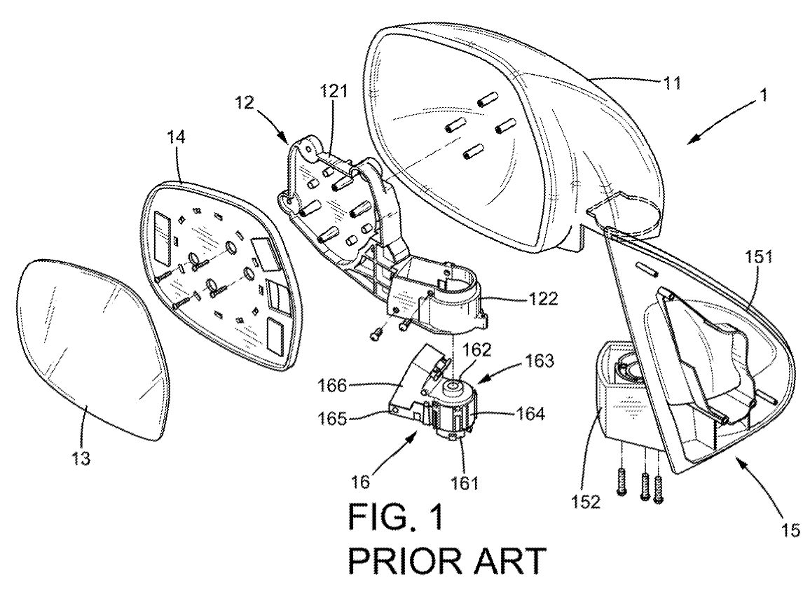

The manually operable adjusting device 2 in structure and in manual operation. If the use is intended to replace the adjusting device 2 with an electric adjusting device, only the manually operable adjusting device 2 is removed. This is because the connecting arm 32 is of the type suitable to receive the electric adjusting device. Taking the electric type adjusting device 16 in FIG. 1 as an example, the coupling hole 325 of the sleeve portion 322 of the connection arm 32 is suitable for receiving the motor receiving portion 165 of the support frame 163 of the electric adjusting device 16 whereas the cylindrical hole 323 of the sleeve portion 322 of the connecting arm 32 is suitable for receiving the cylindrical portion 164 of the support frame 163 if the electrical adjusting device 16. Thus, converting a manual foldable exterior rearview mirror 3 into or from an electric foldable exterior rearview mirror can be easily achieved at low costs and in a short period of time according to the preferred teachings of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indication by the appended claims, rather than by the foregoing description, and all changes which come within the meanings and range of equivalency of the claims are intended to be embraced therein.

1. A foldable exterior rearview mirror for a motor vehicle, comprising, in combination:
a housing;
a connecting arm mounted in the housing and including a sleeve portion, with a mirror being adapted to be mounted to the connecting arm;
a bracket adapted to be fixed to a side of a motor vehicle; and
an adjusting device including a pivot shaft and a support frame, with the pivot axle including an axle having a lower end and a base fixed to the lower end of the axle, with the base being mounted to the bracket, with the support frame including a cylindrical portion and a coupling portion extending outward from a periphery of the cylindrical portion, with the cylindrical portion and the coupling portion of the support frame being removably engaged in the sleeve portion of the connecting arm, with the cylindrical portion of the support frame being rotatably mounted around the axle and including an annular compartment in a bottom face thereof, with the base of the pivot shaft being rotatably received in the annular compartment of the cylindrical portion of the support frame.

2. The foldable exterior rearview mirror as claimed in claim 1, with the base including a top face having a plurality of annularly spaced first positioning holes and a plurality of annularly spaced second positioning holes, with an end wall defining the annular compartment of the support frame including a plurality of positioning grooves, with the adjusting device further including, in combination: a positioning mechanism for positioning the support frame relative to the pivot shaft, with the positioning mechanism including a plurality of balls mounted between the top face of the base and the end wall defining the annular compartment; a spring mounted around an upper portion of the axle that extends beyond the cylindrical portion of the support frame; and a positioning ring mounted on top of the axle, with the spring being attached between the positioning ring and a top face of the cylindrical portion of the support frame to bias the cylindrical portion of the support frame toward the base, with each of the plurality of balls having an upper portion received in one of the plurality of positioning grooves of the support frame, with each of the plurality of balls having a lower portion selectively received in one of the plurality of first positioning holes or one of the plurality of second positioning holes.

3. The foldable exterior rearview mirror as claimed in claim 1, with the sleeve portion of the connecting arm including an annular section and a frame section, with the annular section including a cylindrical hole for receiving the cylindrical portion of the support frame, with the frame section including a coupling hole for receiving the coupling portion of the support frame.

4. The foldable exterior rearview mirror as claimed in claim 3, with the frame section of the sleeve portion of the connecting arm including two engaging grooves respectively in two opposite lateral walls thereof, and with the coupling portion of the support frame including two projections respectively on two opposite walls thereof and slidably received in the engaging grooves of the frame section of the sleeve portion of the connecting arm.

5. The foldable exterior rearview mirror as claimed in claim 4, with the frame section of the sleeve portion of the connecting arm including a plurality of first holes, with the coupling portion of the support frame including a plurality of second holes, further including, in combination: a plurality of screws extending through the first holes into the second holes for securely fixing the coupling portion of the support frame in the frame section of the sleeve portion of the connecting arm.

6. The foldable exterior rearview mirror for a motor vehicle, comprising, in combination:
a housing;
a connecting arm mounted in the housing and including a sleeve portion, with a mirror being adapted to be mounted to the connecting arm;
a bracket adapted to be fixed to a side of a motor vehicle;
a manual adjusting device including a pivot shaft and a support frame, with the pivot axle including an axle having a lower end and a base fixed to the lower end of the axle, with the base being mounted to the bracket, with the support frame including a cylindrical portion and a coupling portion extending outward from a periphery of the cylindrical portion, with the cylindrical portion and the coupling portion of the support frame being removably engaged in the sleeve portion of the connecting arm, with the cylindrical portion of the support frame being rotatably mounted around the axle and including an annular compartment in a bottom face thereof, with the base of the pivot shaft being rotatably received in the annular compartment of the cylindrical portion of the support frame; and
an electric adjusting device removably engaged in the sleeve portion of the connecting arm;
with one of the electric adjusting device and the manual adjusting device being selected to be mounted in the sleeve portion of the connecting arm.

7. The foldable exterior rearview mirror as claimed in claim 1, with the base including a top face having a plurality of annularly spaced first positioning holes and a plurality of annularly spaced second positioning holes, with an end wall defining the annular compartment of the support frame including a plurality of positioning grooves, with the adjusting device further including, in combination: a positioning mechanism for positioning the support frame relative to the pivot shaft, with the positioning mechanism including a plurality of balls mounted between the top face of the base and the end wall defining the annular compartment; a spring mounted around an upper portion of the axle that extends beyond the cylindrical portion of the support frame; and a positioning ring mounted on top of the axle, with the spring being attached between the positioning ring and a top face of the cylindrical portion of the support frame to bias the cylindrical portion of the support frame toward the base, with each of the plurality of balls having an upper portion received in one of the plurality of positioning grooves of the support frame, with each of the plurality of balls having a lower portion selectively received in one of the plurality of first positioning holes or one of the plurality of second positioning holes.

8. The foldable exterior rearview mirror as claimed in claim 6, with the sleeve portion of the connecting arm including an annular section and a frame section, with the annular section including a cylindrical hole for receiving the cylindrical portion of the support frame, with the frame section including a coupling hole for receiving the coupling portion of the support frame.

9. The foldable exterior rearview mirror as claimed in claim 8, with the frame section of the sleeve portion of the connecting arm including two engaging grooves respectively in two opposite lateral walls thereof, and with the coupling portion of the support frame including two projections respectively on two opposite walls thereof and slidably received in the engaging grooves of the frame section of the sleeve portion of the connecting arm.

10. The foldable exterior rearview mirror as claimed in claim 9, with the frame section of the sleeve portion of the connecting arm including a plurality of first holes, with the coupling portion of the support frame including a plurality of second holes, further including, in combination: a plurality of screws extending through the first holes into the second holes for securely fixing the coupling portion of the support frame in the frame section of the sleeve portion of the connecting arm.
